(19) United States
(12) Patent Application Publication
(10) Pub. No.: US 2026/0216724 A1
(43) Pub. Date: Jul. 30, 2026

(54) Suction Head

(71) Applicant: Lizenzia GmbH, Gwatt (CH)

(72) Inventor: Fritz Gyger, Gwatt (CH)

(73) Assignee: Lizenzia GmbH, Gwatt (CH)

(21) Appl. No.: 19/148,835

(22) PCT Filed: Jan. 23, 2024
(86) PCT No.: PCT/EP2024/051538

§ 371 Date: Jul. 17, 2025

(30) Foreign Application Priority Data
Jan. 25, 2023 (EP) 23153274.8

(51) Int. Cl. B01L 3/00

(52) U.S. Cl. CPC B01L 3/502715; B01L 2200/027; B01L 2200/0689; B01L 2300/0681; B01L 2400/049

(57) ABSTRACT

A suction head to suck a liquid out of a microplate that is equipped with a filter includes a collection container and a microplate-mount to lock the microplate into position and to seal a connection between the suction head and the microplate, where the microplate-mount has an opening towards the collection container. The suction head also includes a suction vent at the collection container. The mounting of a microplate on the microplate-mount creates a contiguous cavity between the microplate and the collection container. By applying a negative pressure at the suction vent, the liquid in the microplate is sucked through the filter and through the opening of the microplate-mount into the collection container. Such a device allows for a simple and reliable filtration of liquid out of a number of wells of a microplate. The device additionally allows for safe filtration of dangerous liquids.

### TECHNICAL FIELD

The invention relates to a suction head to suck a liquid out of a microplate that is equipped with a filter. The invention further relates to a filtration system and a dispensing and filtration system with such a suction head. Furthermore, the invention relates to a method for the automatic injection of liquid into a microplate and filtration of liquid out of the microplate.

### BACKGROUND ART

In the pharmaceutical sector, e.g. the drug discovery or in other fields of research, like biology or biomedicine, synthetic peptides play an important role. These chains of molecules can be synthesized step by step using the method of solid-phase synthesis (SPPS), starting from a first amino acid, chemically linked to e.g. a resin bead. To prevent unwanted reactions, these amino acids are protected on their, otherwise reactive, uncoupled ends. Only when adding another substance the protection is removed and the amino acid on the bead can be brought to reaction with another suitably activated amino acid. The result of such a cycle is a longer chain of amino acids linked to the resin bead where the end of the chain again is chemically protected. Repeated cycles of deprotection and subsequent coupling need to be performed, until a chain of amino acids with the desired length and sequence is produced.

Other chain-like molecules like deoxyribonucleic acids (DNA) can be produced in comparable processes. For modern research it is indispensable to automate these kind of processes as much as possible, in particular when many different such molecules are to be produced in parallel.

Automated dispensing units can tremendously improve the throughput in some of the mentioned steps by automatically dispensing the necessary liquids for the synthesis into several reaction vessels like the wells of a microplate.

However the production of e.g. peptides usually also requires additional steps, where unwanted liquids need to be removed from the reaction vessel before the next step in the production can be taken. One process for example is washing, which is repeatedly done during and after the above mentioned cycles to remove excess reagents from the reaction vessels. Another example is cleaving, where the peptides that are linked to the resin beads are released from the beads and also completely deprotected by the addition of a cocktail of substances, e.g. containing trifluoroacetic acid (TFA).

Several concepts to achieve an automatic removal of liquids from a reaction vessel exist: Commercially available dispensing and washing units e.g. are equipped with several aspiration needles that are moved into the vessel to suck out the liquid.

Here the disadvantage is possible clogging of the needles and the need to separately rinse the needles, preferably after each step. Also the size of the reaction vessel poses a geometrical constraint for the maximum needle size and vice versa, meaning that only a limited density of reaction vessels on a certain space can be used with this type of device. Another method to remove liquid from the reaction vessel in the context of automatic peptide synthesis is given in the US 2019/0194246 A1 (CEM Corporation). Here an improved method of deprotection in solid phase peptide synthesis is disclosed. The proposed method includes the step of reducing the ambient pressure within the reaction vessel with a vacuum pull and thereby remove the liquid by evaporation. This can be combined with a microwave heating of the liquids to additionally accelerate the vacuum removal. This can allow to perform peptide synthesis while avoiding the washing steps and two of the draining steps.

A disadvantage of this method is the complicated device needed to perform the disclosed steps. Evaporation processes suffer from condensation and great care needs to be taken to ensure that no condensate interferes with other steps during a process like peptide synthesis. Additionally the process is temperature dependent, which means that additional equipment may be needed, like a microwave heating that is also mentioned in the US 2019/0194246 A1 (CEM Corporation) and rendering the equipment expensive and complicated. A third disadvantage is that cleaving in a peptide synthesis as described above cannot easily be performed this way as here the liquid itself is of interest and would need to be regained from the vapour.

Additionally, cleaving might be done by the use of a substance that is harmful for humans rendering any evaporation of this substance potentially dangerous. This would enhance the complexity of the process further as protection of any personnel would need to be ensured.

### SUMMARY OF THE INVENTION

It is the object of the invention to create a method and a device pertaining to the technical field initially mentioned, that allow for a simple and reliable filtration of liquid out of a number of wells of a microplate.

The solution of the invention is specified by the features of claim 1. According to the invention, a suction head comprises a collection container, a microplate-mount and a suction vent at the collection container.

The microplate-mount serves to lock the microplate into position and to seal a connection between the suction head and the microplate and has an opening towards the collection container. The collection container, the microplate-mount and the suction vent are arranged in such a way that the mounting of the microplate on the microplate-mount creates a contiguous cavity between the microplate and the collection container. By applying a negative pressure at the suction vent, the liquid in the microplate is sucked through the filter and through the opening of the microplate-mount into the collection container.

Such a suction head is a device that allows for the filtration of liquid from a number of wells of a microplate.

To describe the orientation of devices or components, in the following the words up, down, upper, lower, horizontally etc., are used. The invention will usually be used in a surrounding with a gravitational force and these words then indicate the intended orientation relative to this force, in the usual way.

In the following the term liquid is indicating the liquid substance that is supposed to be filtered from the microplate. A liquid is any kind of substance that is liquid or viscous during the usage of the suction head. In most applications it will be liquid at room temperature but it is possible that it is a cooled-down substance that would be gaseous at room temperature or a heated substance that would be solid at room temperature. Instead or in addition of substance temperature, the inventive device may be used in surrounding conditions that are artificially created to maintain the substance in a liquid state, e.g. by lowering or increasing the surrounding temperature and/or by lowering or increasing the ambient pressure.

A microplate is a flat plate with multiple openings, called wells, which can be used as sample holders or test tubes for the parallel conduction of chemical experiments and/or preparations of chemical substances. One microplate usually comprises from 96 up to 384 wells (with variants with less or more wells) and is usually of rectangular form. In the following, the term “microplate” indicates a microplate where the wells feature a through-hole leading through the base of the microplate, i.e. each well features a channel from the upper side of the microplate to its bottom side. This kind of microplate is commercially available or can be produced in a laboratory environment by drilling holes into a commercial microplate that originally had no such holes. A preferred material for such a microplate is polypropylene.

A filter can be any material that is permeable to the liquid used or constituents thereof, at least when the liquid exerts a minimal pressure on the material. This may e.g. be a commercially available filter paper. It might be useful for certain applications of the invention that the filter material is of limited permeability when the liquid exerts only the hydrostatic pressure that originates from the amount of liquid filling a microplate well.

In particular, a filter is contained in each of the wells (or a designated subgroup of the wells). Alternatively, in principle a common filter for several or all the wells might be attached to the underside of the microplate.

When a higher pressure of the surrounding gas, usually air, exists over the microplate compared to below the microplate, the gas above the microplate exerts a force on the liquid in the microplate wells and pushes the liquid through the filter. According to the invention, this pressure difference is created by establishing a negative pressure underneath the microplate. Here a negative pressure indicates a pressure that is lower than the gas pressure surrounding the suction head when a microplate is mounted on the microplate-mount. In most applications this surrounding pressure will be normal air pressure but it is also possible that it is the pressure of an artificial surrounding atmosphere, of e.g. pure nitrogen gas.

The force created due to a pressure difference, especially due to the presence of a negative pressure, is called suction in the following.

A microplate-mount is a region of the suction head that contains functional elements to lock a microplate into position over the collection container. The microplate-mount of the invention locks the microplate into position on the suction head such that the microplate cannot move freely in relation to the suction head and/or the collection container.

The microplate-mount features an opening towards the collection container such that air and liquid can pass through a majority (in particular all) of the microplate wells and into the collection container, as long as these wells are not blocked for the respective substance by other means, e.g. by a filter.

Preferably this opening is contiguous, which makes it easily producible and transmits the negative pressure of the collection container also to microplates with large numbers of wells like microplates with 1536 wells.

The microplate-mount also creates a connection that is sealed tight enough to uphold a negative pressure in the collection container and prevents airflow between the microplate and the collection container other than airflow through the microplate wells.

For that purpose the microplate mount comprises a contact surface such that when a microplate is placed onto the microplate-mount it forms a continuous contact region with the microplate around the opening of the microplate-mount.

Preferably the microplate-mount can feature one or more surfaces that form additional surface regions to stabilize the microplate against movements, e.g. horizontal or vertical movements and to ensure correct placement of the microplate in relation to the suction head. This can be achieved by additional parts of the microplate-mount that surround a microplate that is inserted into the microplate-mount.

Additionally, the microplate-mount can preferably also feature components that are movable and can exert a force onto the microplate such that the force strengthens the mutual contact in the contact region described above. This can e.g. be achieved by clamping blocks that are connected to the suction head by screws. Such a clamping block can overlap at least a part of the microplate. When the screw is fastened the clamping block is brought closer to the collection container and the part of the clamping block that overlaps a part of the microplate pushes the microplate against the contact surface of the microplate-mount. Alternatively the contact surface of the microplate-mount that forms the contact region to the microplate can be of such quality that the microplate does not need to be additionally pushed against the collection container.

A suction vent is a channel that can transport gas and liquid at least from the contiguous cavity between the collection container and a mounted microplate to outside of the suction head. By applying a negative pressure at one side of the suction vent, air will flow through it and transmit the negative pressure to the other side of the vent. Thereby a negative pressure that is applied outside of the suction head at the suction vent is transmitted into the collection container of the suction head, as air moves out of the collection container through the suction vent. The suction vent is also the channel through which the liquid is removed from the collection container. In a preferred embodiment of the invention, the collection container has exactly one vent, the suction vent, apart from the microplate-mount. Alternatively there can be several vents at the suction head, where at least one of them acts as the suction vent.

There are different means of creating a negative pressure at the end of the suction vent. Many chemical laboratories can provide a negative pressure already with their standard installation. In other cases a local vacuum pump can be used. Many different types of vacuum pumps are known and commercially available.

The negative pressure created by this external equipment and the equipment itself will be called the laboratory vacuum herein.

A collection container is a component of the suction head that, at least partially, preferably completely, encloses a region of a certain volume between a mounted microplate on the microplate-mount and the suction vent. This volume is a contiguous cavity that allows gas or liquid to move from the accommodation for the microplate provided by the microplate-mount into the suction vent.

Through the collection container a negative pressure from outside of the suction vent can be transmitted to the bottom of the microplate and create a suction force on a majority of the microplate wells, to suck the liquid out of the microplate and into the region described above. The collection container can e.g. also be equipped with multiple suction vents. To create a negative pressure inside the collection container a negative pressure can be applied to all of them, or alternatively the negative pressure is applied to one or some of them while the rest is blocked.

Preferably the collection container has the shape of a cuboid and a recess on its upper side, creating an enclosed volume that is only open on top. This recess preferably has a horizontal geometry in its upper region that matches the horizontal geometry of the distribution of the wells on a microplate.

Preferably the collection container comprises parts that contain or are completely manufactured out of polyether ether ketone (PEEK) but other materials like e.g. aluminium, ceramic or stainless steel are also possible.

The suction head with its microplate-mount, the suction vent and the collection container creates a device that allows to suck out the liquid from a number of wells in a microplate by mounting a microplate into the microplate-mount and applying a negative pressure to the suction vent. The collection container will transmit the negative pressure to the bottom side of the microplate, where a suction will act on the liquid in the microplate wells. This suction will pull the liquid through the filter of the microplate wells and into the collection container. This allows for a simple and reliable filtration of liquid out of a number of wells of a microplate. Depending on the intended use, either the remaining filtrate in the microplate can be further processed (e.g. for a washing during an SPPS as described above) or the liquid itself can be collected and used (e.g. after a cleaving during an SPPS as described above).

In a preferred embodiment of the invention the microplate-mount comprises a gasket, in particular a polytetrafluoroethylene (PTFE) gasket. This ensures an airtight connection between the microplate and the suction head, apart from the microplate wells. Alternatively microplates can be used, that themselves feature a gasket on their bottom side or have sufficiently flat surfaces that do not need a gasket to create an airtight connection. A gasket, in particular a PTFE gasket, as part of the microplate-mount has the advantage of lower requirements for the used microplates. PTFE has the advantage of a high chemical stability.

Preferably an inner surface of the collection container is sloped with the suction vent being placed at a bottom of this slope within the collection container. Sloped here generally means that on every point on the inner surface a path exists that leads to the lowest height that is assumed by the inner surface, without need to climb at any point along this path. In a preferred embodiment, this is realized by an inner surface that has at least one flat face that is inclined compared to the horizontal plane (in relation to the direction of the gravitational force). Alternatively this can be any other shape that fulfills this requirement.

A bottom of the slope indicates a region where the inner surface of the collection container has its lowest height and can be a point, a curve, a surface or several of any of these. To be placed at the bottom of the slope means that a point that is part of the suction vent is equal to any of the described points that comprise the bottom of the slope.

In a preferred embodiment of the invention, the inner surface of the collection container has a form where the bottom of the slope is one contiguous region and the suction vent is placed at this region. This can e.g. be achieved by a collection container that is formed by a body with a recess on its upper side that has the shape of a cuboid, where an upper face is horizontal and forms the opening towards the microplate-mount, four faces are vertical and form the walls and a lower face forms the bottom of the recess. The bottom can now be inclined to form a slope in comparison with a horizontal plane. Additionally the vertical wall that is adjacent to the bottom of this slope can take an angle other than 90°with its two other adjacent vertical faces. Thereby the lowest height of the recess will be one corner of the cuboid and here the suction vent can be placed.

Alternatively the inner surface of the collection container can have any other form. The advantage of having a sloped inner surface is, that liquid that enters the collection container from above will flow down the slope and thereby gather at an intended region, where the suction vent is placed. This allows to efficiently suck the liquid from the suction head out of the collection container through the suction vent and thereby allowing the next use of the suction head.

In a preferred embodiment of the invention the suction vent comprises a check valve to prevent liquid from leaking out of the suction head in a closed position of the check valve. A check valve is a valve that comprises a mechanism that closes the valve when a specific force is not acting on the check valve. This embodiment enables the suction head to be reliably used also in installations where the suction head is temporarily disconnected from the laboratory vacuum. A check valve at the suction vent then closes the suction vent and thereby prevents any unwanted leakage. This has the advantage that the suction head can also be used with liquids that need to be handled with care as they might damage other equipment or even be harmful to humans. Alternatively the suction vent can be left without a check valve, e.g. when the liquids are uncritical to both equipment and humans and a leakage is acceptable. Also, in embodiments, where the suction head is permanently connected to the laboratory vacuum, a check valve could be omitted.

In a preferred embodiment, the check valve opens when a push force from outside of the suction head is applied to a spring loaded body inside of the check valve. Such a push force could be imparted by a connector unit as described further below. A check valve like this can be easily opened externally to allow a connection between the suction head and the laboratory vacuum and it closes automatically once the connection is cut.

The advantage of this type of check valve is, that it closes the suction vent of the collection container and thereby stops any liquid from flowing through the suction vent in an unwanted fashion immediately when the connection to parts outside of the suction head is closed. Only when the push force is applied it opens and lets gas or liquid pass the suction vent.

In another preferred embodiment the check valve can comprise a spring loaded body that only opens when a strong enough push force from inside the collection container pushes against the body. Here the check valve will open, when a negative pressure is applied to the outer end of the suction vent, but block the suction vent, when no such negative pressure is present, i.e. the spring force pushes against any hydrostatic pressure of the liquid within the collection container.

In yet another alternative embodiment the check valve comprises an electromagnet. With this electromagnet it can be opened or closed electrically by powering the electromagnet or turning it off. Alternatively also a check valve can be used where an external electromagnet that exerts a force on the check valve opens or closes it. Further alternative would be check valves that open or close by other electrical means, like an electric motor, pneumatic or hydraulic means.

Preferably the check valve comprises parts made out of one of the materials: Stainless steel 1.4401 (grade 316) or stainless steel 1.4404 (grade 316 L). Alternatively it can also be produced of other materials like alloys that include e.g. aluminium or titanium or tantalum. Especially preferred embodiments of the check valve comprise parts that are made out of sapphire and/or parts made out of ruby.

Preferably the check valve in any of the embodiments described, comprises a ball whose position within the valve opens or closes the valve.

Preferably the suction head has a contact geometry on an outer face opposite the microplate-mount that matches an accommodation geometry of its own microplate-mount. This allows the suction head to be placed into a type of mount that also locks microplates into place, especially within dispensing systems. A contact geometry is one or several outer surfaces that come into contact with mounts when the suction head is placed into such a mount. An accommodation geometry here indicates the collection of faces on the microplate-mount that form contact regions when a microplate is inserted into the microplate-mount. This does not necessarily also include additional contact regions that are created only when the microplate is locked in place after their insertion into the microplate-mount, e.g. by fastening screws or closing some types of clamps.

When the suction head features a geometry that matches this accommodation geometry it can be placed into such microplate-mounts. And as the microplate-mount of the suction head itself has an accommodation geometry for one or several types of microplates, the suction head will fit into a range of microplate-mounts that were designed for this type of microplates. Therefore, the suction head constitutes an adapter that provides the same accommodation as the element the suction head is attached to, and the same microplate may be used together with this element selectively with or without the adapter.

Preferably, the contact geometry on the suction head is arranged such that a microplate that is mounted onto the microplate-mount of the suction-head, with the suction head being inserted into an external mount, is only displaced vertically compared to the case where the microplate is directly placed into the external mount without a suction head in between.

In a preferred embodiment of the invention the maximum height of the suction head is less than 30% of its maximum width. Maximum height indicates the maximum dimension of the suction head along a vertical line, while maximum width is its maximum dimension along a horizontal line. The advantage of a height that is less than 30% of the maximum width is that it creates a body that is relatively flat and thereby well suited for applications where the height of the suction head matters. This is e.g. the case where the suction head is inserted into laboratory equipment that was not originally designed with the suction head in mind and thereby imposes constraints for a possible suction head. Especially when the top of a microplate still needs to be accessed by such an equipment. Alternatively the suction head can have any other relative dimensions, with the disadvantage that it might not be easily integrated into existing equipment.

A preferred embodiment of the invention is a filtration system comprising the suction head as described above together with a vacuum unit that is connectable to the suction vent of the suction head and comprises a vacuum connection that is connectable to a vacuum source. The vacuum source can be any external laboratory vacuum like a local vacuum pump or an installed vacuum system..

The vacuum unit interfaces between the laboratory vacuum and the suction head. It is connectable to the suction vent of the suction head and when a connection is open between the suction head and the vacuum connection it transfers a negative pressure from the laboratory vacuum to the suction vent of the suction head.

Alternatively, the suction head could itself comprise a vacuum pump without need for further connection. Or the suction head could be connected to the laboratory vacuum without a vacuum unit, but then the laboratory vacuum and the suction head need to be compatible.

In a preferred embodiment of the filtration system the vacuum unit comprises a vacuum valve, where the vacuum valve is connectable to the suction vent, and has an open configuration and a closed configuration, where the open configuration opens the connection to the suction head and the closed configuration closes the connection.

When the vacuum unit is connected to the suction head and the laboratory vacuum and the vacuum valve is opened, the vacuum unit transmits the negative pressure from the laboratory vacuum to the suction head. Preferably the vacuum valve is a two port valve that can be opened or closed electrically and in an especially preferred embodiment it can be opened or closed by an external signal, either an analogue or a digital signal. Alternatively it can also be a manual valve. Also alternatively the vacuum unit can be designed without a vacuum valve. In this case, to switch off the negative pressure at the suction head either the connection to the suction head is cut or the laboratory vacuum is turned off.

Preferably the suction head is movable independently of the vacuum unit within a certain range and where this range includes at least one contact position for the suction head in which the filtration system has a configuration such that the vacuum unit is connected to the suction head.

“Connected” specifies that the vacuum unit establishes a negative pressure in the suction head with a mounted microplate, when a negative pressure is present at the vacuum connection of the vacuum unit and (if present) the vacuum valve of the vacuum unit is opened. In contrast *unconnected* or *disconnected* specifies that the vacuum unit does not establish a negative pressure in the suction head with a mounted microplate, even when negative pressure is present at the vacuum connection and the vacuum valve is opened.

In a filtration system as described above the suction head with a mounted microplate can be moved e.g. to use the microplate in other processes than the filtration such as the dispensing of liquids into the microplate. However, for the filtration to happen, the suction head needs to be connected to the vacuum unit, at least temporarily. Therefore the range of movement needs to include at least one contact position for the suction head with the vacuum unit that enables a connection as described above. Either the suction head is connected to the vacuum unit permanently e.g. with a flexible tube that allows a certain range of movement, or the filtration system is only temporarily connected and is disconnected again, when the suction head with a mounted microplate is used in other processes. The filtration system can e.g. be designed such that when the suction head is in a contact position, the suction vent and a part of the vacuum unit have a contact region that establishes a connection between the suction head and the vacuum valve. When the vacuum valve is now opened, the negative pressure from the laboratory vacuum establishes the negative pressure in the suction head and potentially strengthens the connection.

The independence of the suction head has the advantage that the system allows for the easy integration of the suction head in workflows that require a movement of the microplate. Alternatively the vacuum unit can be permanently fixed to the suction head in a way that no relative movement of the two components is possible. This has the disadvantage that the vacuum unit needs to be moved together with the suction head or that the process needs to be adapted to a fixed microplate.

In a preferred embodiment of the invention the filtration system has a vacuum unit that comprises a connector unit and, while the suction head is placed in a contact position with the vacuum unit, the connector unit has a connected configuration in which it is connected to the suction vent of the suction head and an unconnected configuration where it is not connected to the suction head and where the connector unit is switchable from the connected configuration to the unconnected configuration and vice versa.

A connected configuration specifies a configuration where the vacuum unit is connected to the suction head, whereas an unconnected configuration specifies that that the suction head and the vacuum unit are unconnected.

The ability to switch indicates that the connector unit can establish and cut a connection between the suction head and the vacuum unit reproducibly either electrically or by a mechanical manipulation of a laboratory technician.

Such a connector unit is a part of the vacuum unit and as such it is connected to the vacuum valve of the vacuum unit, if the vacuum unit has such a valve, or it is connectable to the laboratory vacuum itself. It is connectable to and separable from the suction head as long as the suction head is in a specific contact position in relation to the vacuum unit. The connector unit can connect to the suction head e.g. by moving a part into the suction vent of the suction head or by moving a part against the suction head at the place of the suction vent. Alternatively the contact position of the suction head can already be chosen in a way that the suction vent is touching the connector unit and the connector unit opens or closes an internal valve to establish the connection of the suction head to the vacuum unit. Alternatively the vacuum unit can be designed without a connector unit, e.g. with a flexible tube that permanently connects the vacuum unit and the suction head.

In cases where the filtration system is temporally unconnected, the connection can either be established by an electrical signal or by a manipulation of a laboratory technician and is preferably done easily and fast.

A laboratory technician here indicates any human that uses any of the mentioned systems or devices.

Preferably, the connector unit as described above is switched from the unconnected configuration to the connected configuration and vice versa by being moved towards the suction head or away from the suction head. A movably mounted connector unit can establish a connection to the suction head by being moved towards the suction head, into a position where the connector unit is in direct contact with parts of the suction head and thereby connected to the suction head. To disconnect the vacuum unit and the suction head, the connector unit is moved away from the suction head. In a preferred embodiment of the filtration system this type of connector unit is combined with the check valve as described above. By moving into position the connector unit can not only establish a connection between the vacuum unit and the suction head but also open the check valve, e.g. by applying the push force to the spring loaded body within the check valve, or by the force of the negative pressure. Alternatively the connector unit can also make an electrical contact with a suitable check valve to open it or the connector unit can comprise an electromagnet that exerts a force on the check valve to open it.

Conversely the check valve is closed and the connection is cut when the connector unit moves away from the suction head. The movement itself can be caused by a pneumatic or hydraulic cylinder that is connected to the connector unit within the vacuum unit or a stepper motor within the vacuum unit. In alternative embodiments the connector unit may also be fixed with regard to the vacuum unit and establish the connection in another way, e.g. by the pull of an electromagnet.

Another preferred embodiment of the invention is a dispensing and filtration system comprising the filtration system as described above and a dispensing unit for an automatic dispensing of liquid into a microplate, comprising a movable carrier for microplates, where the suction head is installed on this carrier.

A dispensing unit is a device to automatically dispense different liquids in predefined volumes and sequences into specified wells of a microplate. These units are commercially available and in use in many laboratories for different applications like high throughput screening (HTS) or biochemical assays. An example for such a device is the CERTUS FLEX dispensing system produced by Fritz Gyger AG. It features a dispensing head, with several valves for different substances, and this head can move along multiple directions (one direction horizontally and one direction vertically). The dispensing head is placed above a movable carrier for microplates that has a reception geometry to accommodate a microplate. This movable carrier can move along a horizontal direction perpendicular to the horizontal direction of movement of the dispensing head. This allows the dispensing unit to place every valve of its dispensing head above every well of the microplate on the movable carrier. Both the dispensing head and the carrier for microplates are moved by electric motors within the dispensing unit. A precise control of these electric motors and possibly one or several valves allows the dispensing unit the automatic dispensing of liquid into the microplate.

In the preferred embodiment of the invention the suction head from the filtration system as described above is installed on the carrier. Installed means that the suction head is placed onto the carrier in a way that a microplate that is mounted to the microplate-mount of the suction head is still accessible for the automatic dispensing of the dispensing unit.

For this purpose the suction head might be placed onto the part of the carrier that is intended to be in contact with a microplate or that the suction head is placed onto the carrier in a way that contacts other regions of the carrier than a microplate would. The suction head might also be additionally fastened to the carrier.

Preferably, the dispensing and filtration system comprises a control unit that controls the automatic dispensing of liquid into the microplate, the movement of the carrier and can open or close the vacuum valve. Such a control unit can control all relevant parts, e.g. motors, valves and sensors, within the dispensing unit to perform the automatic dispensing. The control unit can also control the movement of the carrier, which it will usually already need to do for the automatic dispensing. Additionally the control unit controls the opening and closing of the vacuum valve within the vacuum unit. This allows to centrally control the dispensing and filtration function of the dispensing and filtration system and thereby coordinate and also program processes in which both filtration and dispensing steps are included.

To control the filtration step, e.g. after a dispensing step, the control unit opens or closes the vacuum valve of the vacuum unit, while the laboratory vacuum does not need to be manipulated. If needed, the control unit can also move the carrier into a contact position with the vacuum unit.

Alternatively, the dispensing unit and the filtration system can be controlled by independent controllers, but this would make processes that include both the filtration and the dispensing more difficult to be automated.

In a preferred embodiment of the dispensing and filtration system the control system also controls the switching between the connected configuration and the unconnected configuration of the connector unit. In this embodiment of the invention the dispensing and filtration system comprises a connector unit at the vacuum unit. The control unit also controls the connector unit to allow full automation of processes including dispensing and filtration steps. Preferably, the vacuum unit is placed within the range of movement of the carrier but outside of the region where the dispensing is performed. The following procedure can serve as an example of the control sequence of the control unit. This is of course not exhaustive nor exclusive to the possible sequences that can be realized by the control unit of such a system:

To start a filtration step, e.g. after a dispensing step, the control unit moves the carrier to the contact position of the vacuum unit. Then it switches the connector unit from the unconnected configuration to the connected configuration. Here e.g. the connector unit moves towards and against the check valve at the suction vent of the suction head and opens this valve by its push force. Now the control unit also opens the vacuum valve and a negative pressure from the laboratory vacuum is transmitted into the suction head. Now the liquid is first sucked from the microplate wells into the suction head and consecutively through the suction vent into the waste container of the laboratory vacuum. To stop the filtration, either the vacuum valve is closed or the connector unit is switched to the unconnected configuration. If both steps are taken the carrier can again move away from the contact position and e. g. under a dispenser head for a new dispensing operation. This allows to perform many dispensing and filtration steps automatically without the need of manipulation by a laboratory technician, which also helps to protect any human from harm by dangerous substances involved.

The invention also relates to a method for the automatic injection of liquid into a microplate and filtration out of a microplate, comprising the steps of:
providing a dispensing unit with a movable carrier;
providing a suction head, the suction head comprising
   a collection container,
   a microplate-mount to lock the microplate into position and to seal a connection between the suction head and the microplate where the microplate-mount has an opening towards the collection container, and
   a suction vent at the collection container;
providing a filter equipped microplate;
mounting the filter equipped microplate onto the suction head, creating a contiguous cavity between the microplate and the collection container;
installing the suction head onto the movable carrier of the dispensing unit;
injecting a liquid into a number of wells in the microplate using the dispensing unit;
applying a negative pressure to the suction vent of the suction head to filter the liquid out of the microplate into the collection container.

The mounting of the microplate onto the suction head and the installation of the suction head onto the movable carrier can be done manually by a laboratory technician or with the help of another device like a handling system that is able to hold and position a microplate or suction head, respectively. There are different ways of installing the suction head onto the movable carrier as described above. Preferably the suction head comprises a geometry that allows to insert the suction head in the same way as a microplate would be inserted into the movable carrier. However it is also possible that the suction head is installed onto the movable carrier in another way.

One application of the inventive method is peptide synthesis. In this case, different liquids need to be added to the reaction vessel at different times during the synthesis. The dispensing unit can do this automatically and can also, depending on the programming, alter the substances in the individual wells of the microplate. The number of wells can be any number between one and the number of wells that are available on a microplate.

By using the suction head as described above the removal of liquid from the microplate can be done without manual handling of the liquid by a laboratory technician and even automatically without removing the microplate from the dispensing unit. This allows also the inclusion of dangerous substances (that e.g. give off toxic vapours) into the process without any danger to humans.

In a preferred embodiment of the method, the dispensing and filtration system as described above is used, comprising a vacuum unit with a connector unit. Then the following steps can advantageously be included in the process:
moving the movable carrier with the suction head from a dispensing position to a contact position with the vacuum unit;
switching the connector unit from the unconnected configuration to the connected configuration;
after filtering the liquid out of the microplate, switching the connector unit from the connected configuration to the unconnected configuration.

According to the first of these steps, the carrier, carrying the suction head and the microplate is moved to a position suitable for the vacuum unit to connect to the suction head. The vacuum unit, comprising a connector unit, needs to connect to the suction head via the connector unit. For this purpose the connector unit is switched to the connected configuration, enabling the vacuum unit to apply a negative pressure at the suction vent of the suction head. Switching from the connected configuration to the unconnected configuration releases the suction head and allows the carrier to e.g. move into a position where the dispensing unit can dispense another liquid into the microplate. It could also move into an extraction position, were either the suction head with the mounted microplate or only the microplate is extracted from the dispensing and filtration system, manually or by a handling device.

Other advantageous embodiments and combinations of features come out from the detailed description below and the entirety of the claims.

### BRIEF DESCRIPTION OF THE DRAWINGS

The drawings used to explain the embodiments show:

FIG. 1 an embodiment of a suction head according to the invention as an isometric projection;

FIG. 2 the suction head as a direct top view;

FIG. 3 the suction head as a direct side view;

FIG. 4 the suction head with a mounted microplate as an isometric projection;

FIG. 5 the suction head with a mounted microplate as a direct top view;

FIG. 6 the suction head with a mounted microplate as a direct side view;

FIG. 7 the suction head with a mounted microplate as a cross sectional view;

FIG. 8A a first embodiment of a check valve for the inventive suction head as cross sectional view;

FIG. 8B a second embodiment of a check valve for the inventive suction head as cross sectional view;

FIG. 9A a first embodiment of a filtration system according to the invention in an unconnected configuration, as a cross sectional view;

FIG. 9B the first embodiment of a filtration system according to the invention in a connected configuration, as a cross sectional view;

FIG. 10A a second embodiment of a filtration system according to the invention in an unconnected configuration, as a cross sectional view;

FIG. 10B a second embodiment of a filtration system according to the invention in a connected configuration, as a cross sectional view;

FIG. 11 the first embodiment of the filtration system as an isometric projection;

FIG. 12 an embodiment of a dispensing and filtration system according to the invention, as a schematic isometric projection.

In the figures, the same components are given the same reference symbols.

### Preferred Embodiments

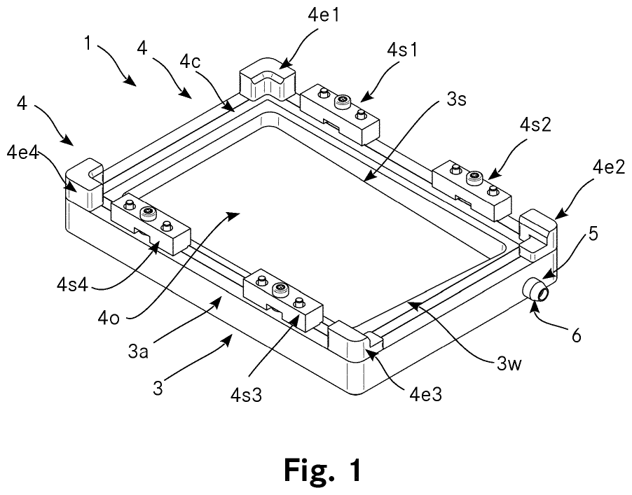

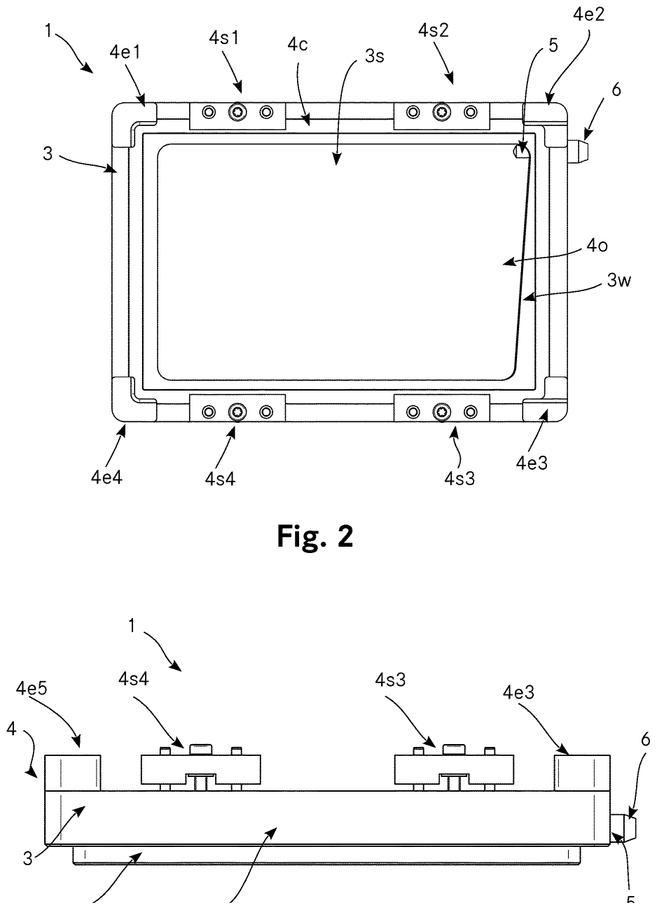

The FIGS. 1-3 show the suction head 1 in an isometric projection (FIG. 1), a direct top view (FIG. 2) and a direct side view (FIG. 3). For the isometric projection of FIG. 1, the height of objects is shown as standing upright in the picture plane, i.e. every edge of an object that is upright when the object is placed on a flat surface is shown upright in the picture plane.

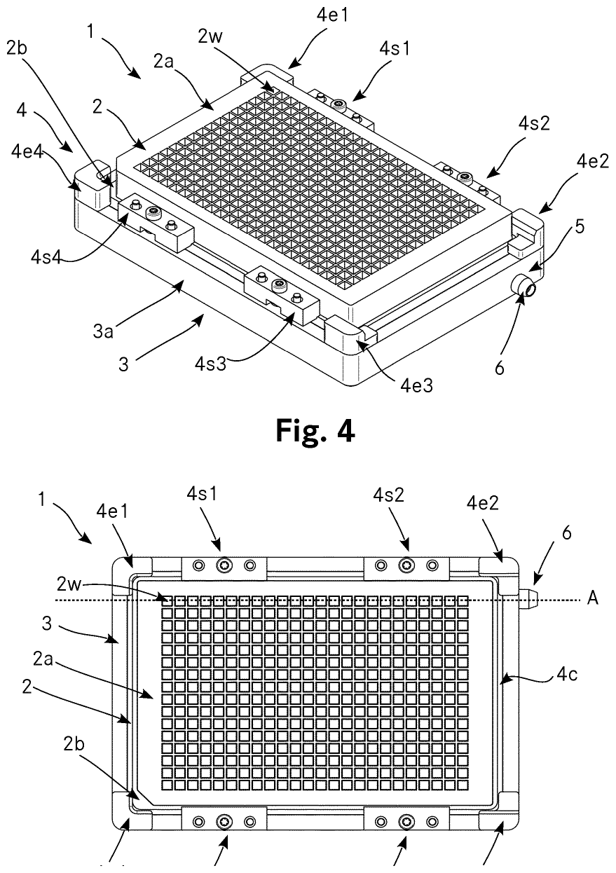

The suction head 1 comprises a collection container 3 and a microplate-mount 4 to lock a microplate 2 (shown in FIG. 4) into position, wherein the microplate mount 4 and the collection container 3 are a unitary component of the suction head 1. The suction head 1 further comprises a suction vent 5 and a check valve 6.

The collection container 3 of the suction head 1 has a body 3a with an outer elongated cuboid shape, i.e. two parallel sides are longer than the other two. The height of the body 3a of the collection container 3 is about 10 % of the length of its longest side. The longer sides are about 1.5 times longer than the shorter sides. On its upper surface, the body 3 a of the collection container 3 has a cuboid recess that creates a basin with a lower surface 3s, four upright side walls and a top opening 40. The wall thickness around this basin is about 10 % of the length of the shorter sides of the collection container 3. The lower surface 3s of the basin is sloped in comparison to a horizontal plane (cf. also FIG. 7). The depth of the basin is at least about 50% of the height of the upper body 3a on the upper part of the slope and about 90% at its deepest point.

In addition, the inner face 3w of the wall that faces the bottom of this slope is angled, i.e. has an angle of about 95° and 85° to the adjacent inner walls. The slope of the inner surface 3s and the inner face 3w create a region in the vicinity of a corner of the collection container 3 where the basin has its maximum depth. Here the suction vent 5 together with the check valve 6 is placed.

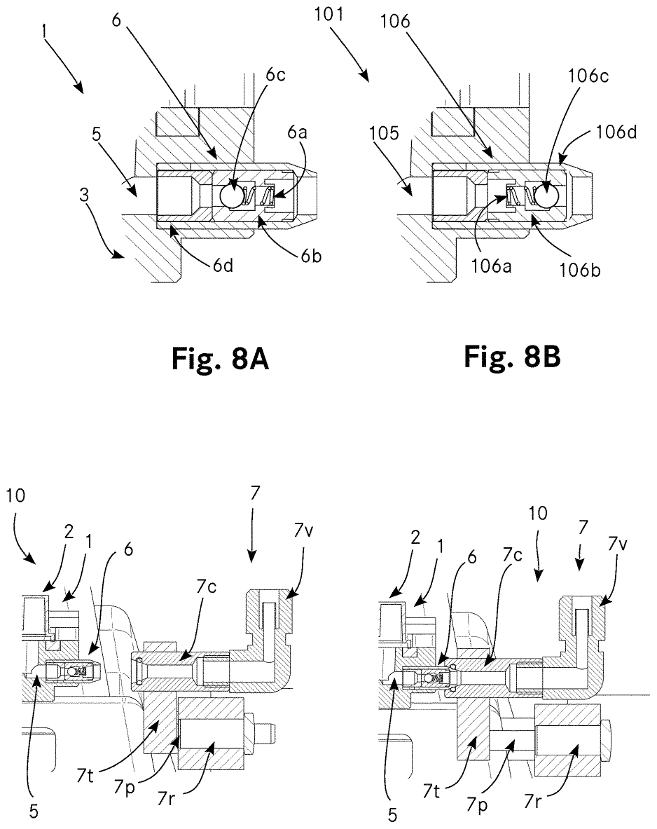

The suction vent 5 is a channel that pierces the outer wall of the collection container 3, leading from the basin to the outer wall of the suction head 1. Its outer opening is round, with a diameter of about 40% of the height of the collection container 3. Within the suction vent 5 and extending outwards and out of the collection container 3 is a check valve 6. A more detailed view of the suction vent 5 and the check valve 6 is given in FIG. 8 and FIG. 9. The upper face of the upper body 3a of the collection container 3 is also the basis for the components of the microplate-mount 4.

The microplate-mount 4 comprises different elements to lock a microplate 2 (see FIG. 4) into place. It also serves to seal the connection between the microplate 2 and the collection container 3.

The components of the microplate-mount 4 are the opening 40, the corner parts 4e 1-4e4, the clamps 4s 1-4s4 and the PTFE (polytetrafluoroethylene) gasket 4c.

The PTFE gasket 4c is the support of the microplate 2 that is placed into the microplate-mount 4. It forms a rectangular closed curve and completely encircles the opening 40 on the upper surface of the collection container 3 (see FIG. 1 or 2). Its thickness is about a third of the wall thickness of the collection container 3, except at the inner face 3w, where the wall is partially thicker due to the inclination of the inner face 3w.

The PTFE gasket 4c is placed in a groove within the upper surface of the walls that surround the basin of the collection container 3 such that in an unstressed position, its upper surface slightly protrudes over the upper surface of the collection container 3 (see FIG. 7).

There are four corner parts 4e1-4e4. Each corner part 4e1-4e4 has the shape of two cuboids that are angled with a right angle to each other. The length of each cuboid part is about 10% of the shorter side length of the collection container 3. Each corner part 4 e 1-4 e4 has a maximum height that is about 70% of the height of the collection container 3.

The corner parts 4e1-4e4 are mounted on top of the walls of the basin of the collection container 3, directly above each one of the four corners of the collection container 3 and flush with the outer side walls. The thickness of the corner parts is about 50% of the wall thickness of the basin of the collection container 3. The inner faces of the corner parts 4e 1-4e4 slightly overlap the PTFE gasket 4c but leave enough space for a microplate 2 to be placed onto the gasket 4c. The corner parts 4e2 and 4e3 have a reduced height (about 50 % of their maximum height) at those cuboid parts that are placed above the shorter face of the collection container 3 accommodating the suction vent 5.

The microplate-mount 4 further comprises the four clamps 4s 1-4s4, which are fastened onto the upper face of the collection container 3, along its longer sides, flushing with its side walls.

Each clamp 4s1-4s4 has the shape of a cuboid with an oblong rectangular footprint. The longer side walls of each clamp 4s 1-4s4 are about one fifth of the length of the longer side walls of the collection container 3. The longer side walls of the clamps 4s1-4s4 are also aligned with the longer side walls of the collection container 3. The length of the shorter side walls of the clamps 4s1-4s4 is such that they flush with the outer side walls of the collection container 3 on one side and on the opposite side almost completely overlap the PTFE gasket 4c. The height of the clamps 4s1-4s 4 is about 40% of the height of the upper body 3a of the collection container 3.

On the lower face of the clamps 4s1-4s4, at the edge that faces towards the opening 40, the clamps 4s 1-4s4 have a slight indentation. This creates a contact region on the clamps 4s1-4s4 that does not only touch a microplate 2 (FIG. 4) attached to the suction head 1 from above but also from the side, additionally securing the microplate 2 against horizontal movements.

There are two clamps 4s 1-4s4 on each side of the basin. Each clamp 4s 1-4s4 is fastened to the upper face of the collection container 3 by a screw having a screw-head resting on the upper side of each clamp 4s 1-4s4. The screw head is placed centrally along the longer side of the clamp 4s1-4s4. Each screw is placed centrally in regard to the wall thickness of the basin of the collection container 3. Additionally, for each of the clamps 4s 1-4s4 two guiding rods are fastened on the upper face of the collection container 3 and penetrate two holes within the clamps 4s1-4s4, arranged on both sides of the screw, along the longitudinal axis of the clamp 4s1-4s4. The guiding rods prevent rotation of each clamp 4s1-4s4 about the screw. Between each clamp 4s1-4s4 and the upper face of the collection container 3 a retaining ring is clamped on the respective screw. This retaining ring is accommodated within a groove on the lower face of each clamp 4s1-4s4. Thereby the screws can not only push down onto the clamps 4s1-4s4 but each clamp 4s1-4s4 can be held up by the respective screw and retaining ring such that the lower face is not touching the upper surface of the collection container 3 (see FIG. 3). The height of the clamps 4s 1-4s4 can be adjusted by unscrewing or fastening of the screws. The screws themselves and thereby also the clamps 4s1-4s4 are fixed captively to the collection container 3.

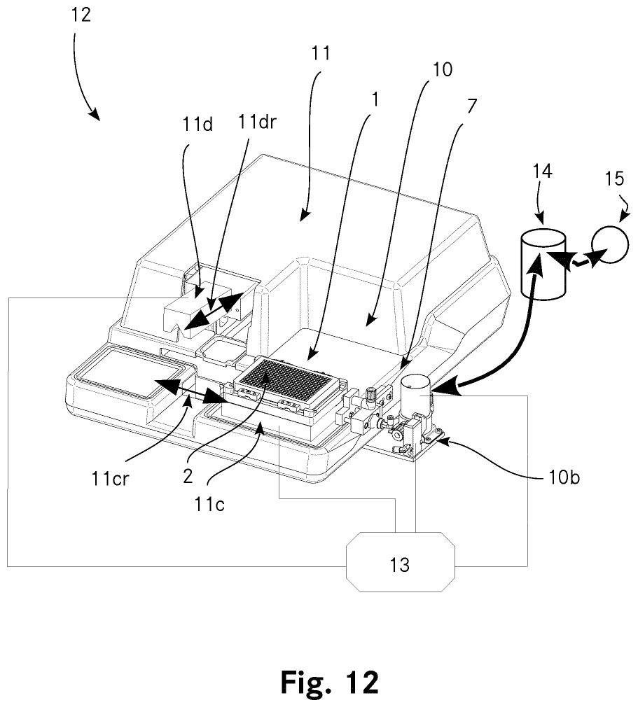

Below the upper body 3a of the collection container 3 is a contact part 3b (see FIG. 3) that is part of the same body, i.e. the upper body 3a and the contact part 3b are made out of a unitary piece of material, in this case polyether ether ketone (PEEK). The contact part 3b of the collection container 3 is a cuboid protrusion from the lower surface of the upper body 3a of the collection container 3. The height of the contact part 3b is about 30% of the height of the upper body 3a of the collection container 3. The bottom surface of the contact part 3b is chosen such that in a horizontal projection of the suction head, the lower edges of the contact part 3b are in the same position as the edges of the PTFE gasket 4c. This way the lower edges of the contact part 3b of the collection container 3 match the lower edges of a microplate 2 within the microplate-mount 4 in their position within a horizontal plain (see FIG. 7). Hence the contact part 3b has a contact geometry that matches an accommodation geometry of the microplate-mount 4. It allows the suction head 1 to be placed into a type of mount that also locks microplates 2 into place, especially within dispensing systems (see FIG. 12).

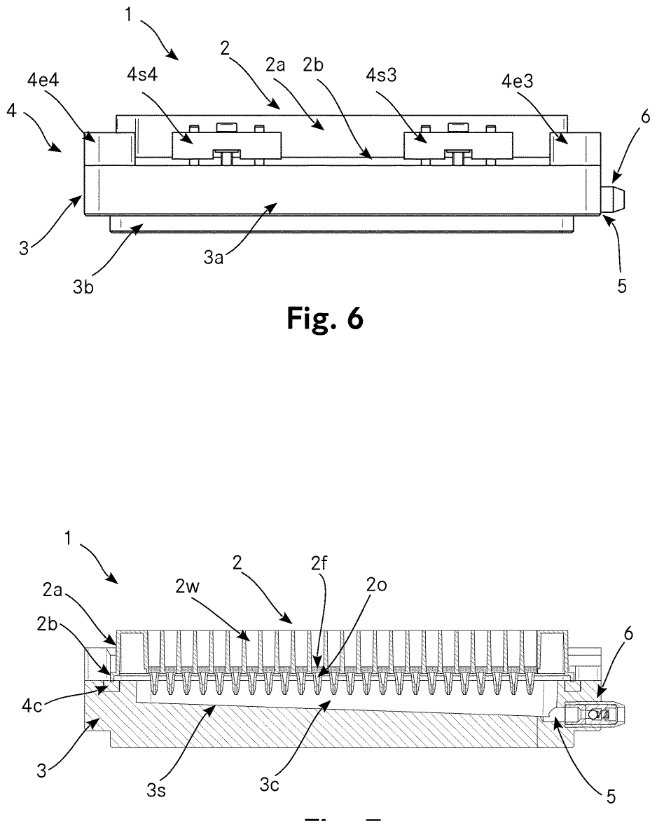

The FIGS. 4, 5, 6 and 7 show the suction head 1 together with a microplate 2 that is mounted onto the microplate-mount 4. FIG. 4 shows the same isometric projection as FIG. 1, FIG. 5 shows a direct top view, FIG. 6 a direct side view and FIG. 7 a cross section along a vertical plane that contains the line A shown in FIG. 5.

The microplate 2 has an upper body 2a whose shape is predominantly cuboid with a rectangular footprint. Its height is about 10% of the length of its longer sides. The longer sides of the cuboid shape are about 1.5 times longer than the shorter sides. Below the upper body 2a, the microplate 2 has a base 2b that also has an outer cuboid shape and extends horizontally outwards of the upper body 2a into all four directions for about 2% of the length of the shorter sides of the upper body 2a. The length of the longer sides of the base 2b is about 128 mm while the shorter sides have a length of about 85 mm. The total height of the microplate 2 is about 14 mm.

The height of the base 2b is about 20% of the height of the upper body 2a of the microplate 2.

One of the outer edges of the upper body 2a is cut off along its height creating a face with a 45° angle to the adjacent side walls of the upper body 2a. This helps to correctly orientate the microplate 2.

The microplate 2 comprises 384 wells 2w, which are arranged in a rectangular matrix with rows of 24 and columns of 16 wells 2w. The wells 2w are rectangular holes that are open on the upper face of the upper body 2a of the microplate 2, separated by walls. The upper faces of the walls and the regions of the microplate 2 outside of the region of the wells 2w form a flat upper face. The microplate 2 is made out of polystyrene but can also be manufactured from polycarbonate or other materials. There are microplates with a different number of wells 2w and the shown microplate 2 only serves as example. Other microplates 2 can e.g. comprise 1536 wells of correspondingly smaller dimensions.

The microplate 2 is mounted onto the microplate-mount 4. The bottom surface of the microplate 2, its outer lower edge, touches exclusively the PTFE gasket 4c. The corner parts 4e1-4e4 of the microplate mount 4 ensure that the microplate 2 is correctly positioned over the collection container 3 by blocking the microplate 2 against horizontal movements. The clamps 4s 1-4s4 reach over the base 2b of the microplate 2 and prevent the microplate 2 from being able to move upwards out of the microplate-mount. Additionally they exert a downward force onto the base 2b of the microplate 2 to push the microplate 2 into the PTFE gasket 4c. The screws can be used to adjust the force that is exerted on the microplate 2 by each of the clamps 4s 1-4s4.

To remove the microplate 2 from the microplate-mount 4, the clamps 4s 1-4s4 can be lifted until they do no longer touch the microplate 2. Then the microplate 2 can be slightly lifted and horizontally slid over the lower parts of the corner parts 4e2 and 4e3 and below the clamps 4s 1-4s4 out of the suction head 1. To mount a microplate 2 onto the microplate-mount 4 these steps are followed in the reverse order.

In FIG. 7, the profile of the Microplate 2 is shown in greater detail, as well as its inner structure. The lower

surface of the base 2b of the microplate 2 only touches the PTFE gasket 4c of the microplate-mount 4. On the lower ends of the wells 2w the wells 2w have a nozzle 20 with a smaller diameter than the upper opening of the wells 2w. Above this nozzle 20 each of the wells 2w is provided with a filter 2f. The nozzles 20 of the wells 2w reach through the opening 40 of the microplate-mount 4. The microplate 2 and the collection container 3 form a contiguous cavity 3c. The cavity 3c is only connected to the outside of the suction head 1 via the suction vent 5 and via the nozzles 20.

When a negative pressure is applied to the outer end of the suction vent 5, it will transmit this negative pressure into the cavity 3c. The negative pressure then acts onto the nozzles 20 of the microplate 2. Liquid above the filter 2f is sucked through the filter and into the cavity 3c. Within the cavity, liquid is guided towards the suction vent 5. The liquid is then also sucked out of the collection container 3 through the suction vent 5.

FIG. 8A and FIG. 8B show a cross section view of two possible embodiments of valves placed in the suction vent. FIG. 8A shows check valve 6 placed in suction vent 5, FIG. 8B shows check valve 106 placed in suction vent 105, respectively.

Check valve 6 according to the first embodiment consists of a sleeve 6d, a spring holder 6b, a spring 6a and a ball 6c. The ball 6c and the spring 6a are placed in the spring holder 6b, which again is held within the sleeve 6d.

The outer sleeve 6d of check valve 6 has a cylinder symmetrical shape, with the symmetry axis being the same as the symmetry axis of the suction vent 5. For about 80% of its length it has the shape of a tube with constant radius and constant wall thickness along the symmetry axis. Only on the outer end of the sleeve 6d, outside of the suction vent 5, it has a conical tapering.

Within the sleeve 6d, the spring holder 6b is placed. It also has a cylinder symmetric outer profile, whose outer diameter matches the inner diameter of the sleeve 6d. Within the spring holder 6b the spring 6a is fastened, with its spring force pushing along the symmetry axis of the sleeve 6d and towards the collection container 3. The unfastened end of the spring 6a reaches into a room within the spring holder 6b. In this room the ball 6c can take several positions. Without an outer force, the ball 6c is pushed by the spring 6a against a valve seat surrounding an opening towards the collection container 3. Thereby it seals a possible passage for gas or liquid to transverse the check valve 6. When an outer force pushes the ball 6c into the room within the spring holder 6b, away from the valve seat, the valve seat is open for liquid or gas to enter the room and to further transverse towards the outer end of the check valve 6.

Only a push force against the ball 6c that comes from inside the collection container 3 can open the check valve 6, e.g. a sufficiently strong pressure from a gas or a liquid within the collection container 3. The strength of the spring 6a is chosen such that the hydrostatic pressure of the liquid coming from the microplate 2 would not suffice to open the check valve, even when the cavity 3c within the collection container 3 is filled by this liquid. Only the application of a negative pressure outside of the suction vent 5 and the check valve 6 can create a pressure difference that creates a push force onto the ball 6c sufficiently strong to open the check valve 6 by compression of the spring 6a.

The check valve 106 according to the second embodiment has a sleeve 106d that is identical to the sleeve 6d of the check valve 6. Also the shape of the spring holder 106b and the placement of the spring 106a and the ball 106c within the spring holder 106b is identical to spring holder 6b. However, the spring holder 106b is placed in such a way within the sleeve 106d that the force of the spring 106a acts along the symmetry axis of the sleeve 106d and away from the collection container 3. As is the case with check valve 6, the check valve 106 opens, when the ball is pushed against the spring 106a by a force stronger than the force of the spring 106a (and any other force in the same direction, as e.g. a hydrostatic pressure inside of the collection container 3). But in this case check valve 106 opens when a push force from outside of the collection container acts on the check valve 106. This way the check valve 106 will stay closed, even when the gas or liquid inside of the collection container 3 exerts a high pressure on the check valve 106 and only a push force that is applied to the spring loaded body, the ball 106c, from outside of the suction head 101 opens it.

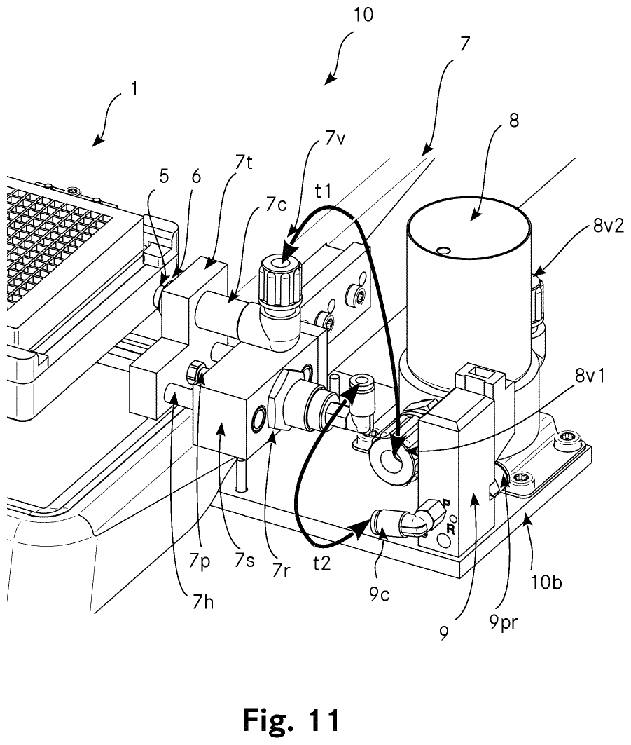

FIG. 9A and FIG. 9B show a cross section view of a part of the suction head 1 with mounted microplate 2 together with a part of the vacuum unit 7, forming a filtration system 10 in two configurations a 10 (FIG. 9A) and b 10 (FIG. 9B). The filtration system 10 comprises the suction head 1 and a vacuum unit 7 that is connectable to the suction vent 5 of the suction head 1, where the vacuum unit 7 comprises a vacuum connection 7v that is connectable to a laboratory vacuum or a vacuum valve 8 (FIG. 11).

The suction head 1 is movable independently of the vacuum unit 7 within a certain range. This range includes at least one contact position for the suction head 1, in which the filtration system 10 has a configuration such that the vacuum unit 7 is connected to the suction head 1 (here the connection is shown as configuration b 10).

The vacuum connection 7v comprises an inner channel that faces towards the suction head 1 in its contact position and upwards on the other end. The end of the channel of the vacuum connection 7v that faces towards the suction head 1 is connected to a connector unit 7c. The connector unit 7c may be selectively connected to the suction vent 5. In the connected configuration b 10 of the filtration system 10, it is connected to the suction vent 5 of the suction head 1 (FIG. 9B). In the unconnected configuration a 10 it is not connected to the suction head 1.

The connector unit 7c has a generally cylinder symmetrical shape with a constant outer diameter and a symmetry axis that is parallel to the symmetry axis of the check valve 6 when the suction head 1 is placed in the contact position. The connector unit 7c features a central channel having a constant circular cross-section along most of its length. In its sections neighbouring its outer ends, the inner diameter of the channel is increased to match the geometry of the components it is connected to. On its end facing towards the suction head 1, the channel of the connector unit 7c has an inner diameter that enlarges towards the end of the connector unit 7c. This way the connector unit 7c forms a contact geometry that matches the tapering of the check valve 6. Additionally the connector unit 7c comprises a gasket to seal the connection to the check valve 6.

On its other end, the channel of the connector unit 7c has an inner diameter that is equal to the outer diameter of the vacuum connection 7v connected to this end.

The connector unit 7c including the vacuum connection 7v attached to it and supported by it may be moved together towards the suction head 1. For this purpose, the connector unit 7c is fixed to a holding plate 7t that has a rectangular cross section. The holding plate 7t itself is connected to a piston 7p of a pneumatic cylinder 7r.

In configuration a 10 of the filtration system 10, shown in FIG. 9A, the connector unit 7c is not extended towards the suction head 1. When the cylinder 7r is pressurized, the piston 7p moves the holding plate 7t and with it the connector unit 7c with the vacuum connection 7v towards the suction head. Thereby it switches the connector unit 7c into the connected configuration b 10, shown in FIG. 9B. In configuration b 10 of the filtration system 10, the connector unit 7c is moved onto the check valve 6. If now a negative pressure is applied to the vacuum connection 7v the negative pressure will be transmitted directly to the check valve 6. With the mechanism described above, the check valve then also opens to let gas and liquid pass out of the suction head 1 and into the vacuum unit 7.

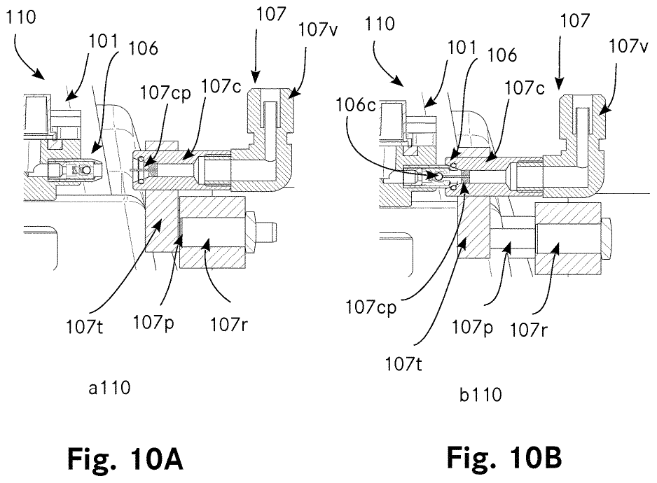

FIG. 10A and FIG. 10B show the filtration system 110, an alternative embodiment of the filtration system 10, again as a cross section and in two configurations, a 110 and b 110.

The overall arrangement is very similar to the filtration system 10 according to the embodiment described in connection with FIG. 9. However in this case the suction head 101 features a check valve 106 that does not open unless a push force from outside of the suction head 101 is applied to the check valve 106. To apply this push force to the check valve 106, the vacuum unit 107 features a connector unit 107c that comprises an opening pin 107cp. Again, the connector unit 107c is fixed to a holding plate 107t that has a rectangular cross section. The holding plate 107t itself is connected to a piston 107p of a pneumatic cylinder 107r.

The opening pin 107cp is fixed to the connector unit 107c within its channel in such a way that liquid and gas can still pass from the suction vent 105 to the vacuum connection 107v. It has a body that is cylinder symmetric with its symmetry axis lying on the symmetry axis of the channel of the connector unit 107c. In the unconnected configuration a110 of the filtration system 110 the connector unit 107c is located in a distance from the check valve 106 and the check valve 106 is closed due to the absence of an outer push force. In configuration b110 the connector unit 107c is moved towards the suction head 101. Here the opening pin 107cp is entering the check valve 106 and pushes against the ball 106c.

This way, the check valve 106 is opened by the connector unit 107c. If now a negative pressure is applied to the vacuum connection 107v this negative pressure is transmitted to the cavity 3c (FIG. 7) within the suction head 101.

FIG. 11 shows the filtration system 10 as an isometric projection from above. On the left of the picture plane the suction head 1 with the suction vent 5 and the check valve 6 is connected to the connector unit 7c of the vacuum unit 7 (configuration b 10 in FIG. 9). In addition to the components shown in detail in FIG. 9, the vacuum unit 7 also comprises a vacuum valve 8 that is connected to the vacuum connection 7v via a tubing connection t1 between the vacuum connection 7v and the connector 8v1. This tubing connection t1 has to be chosen with a length that permits the connector unit 7c and the vacuum connection 7v to take up both the unconnected configuration a 10 and the connected configuration b 10 (both in FIG. 9).

The vacuum valve 8 is connectable to a laboratory vacuum via the connector 8v2. The vacuum valve 8 has an open configuration and a closed configuration, where the open configuration opens the connection to the suction head 1 and the closed configuration closes the connection.

For this purpose, the vacuum valve 8 can open or close the connection between the connector 8v1 and the connector 8v2 internally. The vacuum unit 7 also comprises a pressure valve 9 with a connector 9c. The connector 9c of the pressure valve 9 is connected to the pneumatic cylinder 7r via a tubing connection t2. The pressure valve 9 is connectable to a compressor via a connector 9pr and can act on electrical signals to open or close, extending or retracting the piston 7p to or from the cylinder 7r.

All components of the vacuum unit 7, like the vacuum valve 8, the pressure valve 9, the vacuum connection 7v and the connector unit 7c are supported by a rectangular plate 10b serving as a common base.

On the plate 10b, close to the suction head 1, holding rods extend vertically upwards supporting a holding piece 7s which contains the pneumatic cylinder 7r and two boreholes for guiding rods.

From the holding piece 7s the piston 7p and two guiding rods 7h within the boreholes extend horizontally outwards toward the suction head 1. On their ends, these guiding rods and the piston 7p are fixed to the holding plate 7t, which is supporting the connector unit 7c together with the vacuum connection 7v.

FIG. 12 is an isometric schematic top view of a dispensing and filtration system 12, comprising the filtration system 7 and a dispensing unit 11 for an automatic dispensing of liquid into a microplate 2. The dispensing unit 11 is a CERTUS FLEX dispensing unit that is commercially available from Fritz Gyger AG. The dispensing unit 11 is a device to automatically dispense selected liquids into individual wells of a microplate 2. It comprises a movable carrier 11c for the microplate 2. It further comprises a dispensing head 11d with several valves that allow to dispense small dosages of liquids. The dispensing head 11d has several channels that allow to dispense more than one liquid during the same workflow, i.e. without a manipulation of the dispensing unit 11. The dispensing head 11d can move along a horizontal axis 11dr that is parallel to the shorter sides of the microplate 2. This allows the dispensing head 11d to position any of its several valves above any one of the wells in a column of wells. The dispensing head 11d in this embodiment is also able to change its height to adapt to different installations and types of microplates 2.

The carrier 11c has a contact geometry that allows to insert a microplate 2 into the carrier 11c. It is movable along a horizontal axis 11cr which is perpendicular to the axis 11dr and thereby the direction of movement of the dispensing head 11dr. This way the carrier 11c can be moved under the dispensing head 11d and positioned such that the dispensing head 11d can dispense liquid into any column of wells. By combining the positioning along the axis 11dr and axis 11c the dispensing head 11d can dispense any of the liquid from its valves into any of the wells of the microplate 2.

In the configuration shown in FIG. 12, the suction head 1 of the filtration system 10 is installed on the carrier 11c. For this purpose, the suction head 1 is inserted into the carrier 11c of the dispensing unit 11 with the contact part 3b of the collection container 3 (FIG. 2) such that the body 3a of the collection container 3 is located directly above the carrier 11c. A microplate 2 is mounted on the microplate-mount 4 of the suction head 1 and due to the geometry of the contact part 3b, the microplate 2 is still positioned correctly for the programmed dispensing of liquids by the dispensing unit 11. Due to the maximum height of the suction head 1 being less than 30% of its maximum length, the carrier 11c is still freely movable within its range of movement along the axis 11cr, with no interference with the dispensing head 11d, at least as long the dispensing head 11d is located in an upper section of its vertical range.

The vacuum unit 7 is installed at the side of the dispensing unit 11, with its plate 10b being fixed to the bottom of the dispensing unit 11. It is connected to a waste container 14 via the connector 8v2 of the vacuum valve 8 (FIG. 10) and a laboratory vacuum 15 is connected to the waste container 14. Vacuum unit 7 is placed such that the contact position of the suction head 1 is on the height of the movable carrier 11c and within the range of movement of the carrier 11c. This way the carrier 11c can bring the suction head 1 into the contact position with the vacuum unit 7.

In the context of the displayed embodiment, the contact position and the position that is needed for the dispensing head 11d to dispense liquid into the microplate 2 are not the same positions and for a filtration to take place the carrier 11c needs to move into the contact position and away from the dispensing head 11d. However there are possible embodiments of the invention where this is not the case, e.g. when the vacuum connection 7v of the vacuum unit 7 is permanently connected to the suction head via a flexible tubing. The dispensing function of the dispensing unit, including the movement of the dispensing head 11d, the control of the valves and the movable carrier 11c is controllable by the control unit 13. The control unit 13 also controls the opening and closing of the vacuum valve 8 and the pressure valve 9 (FIG. 10). Thereby the dispensing and filtration system 12 is able to automatically perform both dispensing and filtration actions.

For a filtration step, the movable carrier brings the suction head 1 into a contact position with the vacuum unit 7. Subsequently the connector unit 7c (FIG. 10) of the vacuum unit 7 is switched to a connected configuration by opening the pressure valve 9 (FIG. 10). If also the vacuum valve 8 is opened, a negative pressure from the laboratory vacuum 15 is transmitted to the microplate 2 and the liquid is sucked into the suction head 1 and from there via the check valve 6 (FIG. 1) through the connector unit 7c (FIG. 10) to the vacuum connection 7v (FIG. 10), through the vacuum valve 8 (FIG. 10) and into the waste container 14. To stop the filtration, the vacuum valve 8 can be closed or the connector unit 7c is switched to the unconnected configuration. This dispensing and filtration system 12 allows for automated repeated cycles of dispensing liquid into a microplate and the filtration of that liquid from the microplate without the need of any manual manipulation of the system.

Using the inventive dispensing and filtration system 12, processes like solid phase peptide synthesis, SPPS, can be performed within the wells of the microplate 2. The microplate 2 needs to be prepared with resin beads and a suitable filter.

To add any liquid that is necessary for the process to the microplate 2, the suction head 1 is moved to the dispensing position, where the dispensing system 11 can then dispense the respective liquid into individual wells. These liquids can be substances to unblock the ends of the amino acids of a peptide chain that is being produced. They can also contain the next amino acid to be connected to the peptide chain.

Also, the steps where washing is needed can be performed. For that purpose, first the washing-substances are added to the respective wells of the microplate 2 using the dispensing head 11d. Subsequently the suction head 1 moves into the contact position with the vacuum unit 7. Then the liquid is filtered from the microplate 2 by applying a negative pressure to the suction head 1.

After repeated cycles of coupling and washing the peptides need to be cleaved from the beads. For this purpose a cleaving substance is dispersed into the respective wells of the microplate 2, again using the dispensing head 11d. After the cleaving reaction the peptides within the cleaving substance can also be filtered from the microplate 2 using the suction head 1. For this purpose, again the suction head 1 is moved into contact position with the vacuum unit 7 and a filtration is performed. The liquid that is sucked from the microplate 2 can be collected in a dedicated container 14.

The invention is not limited to the embodiments described above. Alternative embodiments of the invention are possible. The described microplate serves only as an example and can have a different number of wells, such as e.g. 1536 wells. The microplate-mount can feature different elements and/or different numbers of the described elements, e.g. only two clamps and no corner parts. It can have a gasket of another material than PTFE or dispense with a gasket if the contact geometry allows that. The body of the collection container can have a different form, e.g. it could guide the liquid into a reservoir that is not located directly under the microplate. It can also have a different volume and can also be made out of another material than PEEK, e.g. stainless steel or a ceramic material. Also the inner surface of the collection container can have another form and e.g. contain channels for the liquid. The suction vent could have another form and not be round but e.g. oval or square in its profile. The presented check valves are only possible embodiments, the valve body could have a different shape and/or size and the spring could be another type of spring, e.g. a leaf spring. Other check valves, e.g. valves that open electromagnetically are also possible.

The presented filtration system could be realized in a different way, e.g. the vacuum connection could be connected to the connector unit with a telescopic connection such that the vacuum connection does not move when the connector unit is extended or retracted. Also the connector unit could connect or disconnect without being extended, e.g. it could fold into position. It could also open or close the check valve by different means, e.g. by closing an electrical circuit that opens an electromagnetic check valve. The filtration system can also be realized without a connector unit and e.g. have a flexible tubing between the suction head and the vacuum connection that allows for enough range of movement for the suction head. All the stabilizing and supporting parts of the filtration system can of course have different shapes and sizes.

Alternative embodiments exist as well for the dispensing and filtration system. The carrier can be movable along other paths, e.g. along several axes. It could also comprise several dispensing heads. All displayed shapes and (relative) sizes are only meant as examples and can differ.

In summary, it is to be noted that the invention creates a suction head that allows for a simple and reliable filtration of liquid out of a number of wells of a microplate.

1. A suction head to suck a liquid out of a microplate that is equipped with a filter, the suction head comprising
a collection container,
a microplate-mount to lock the microplate into position and to seal a connection between the suction head and the microplate where the microplate-mount has an opening towards the collection container, and
a suction vent at the collection container,
wherein the collection container, the microplate-mount and the suction vent are arranged in such a way that the mounting of the microplate on the microplate-mount creates a contiguous cavity between the microplate and the collection container and that by applying a negative pressure at the suction vent, the liquid in the microplate is sucked through the filter and through the opening of the microplate-mount into the collection container, and
wherein a contact geometry of the suction head on an outer face opposite the microplate-mount matches an accommodation geometry of its own microplate-mount.

2. The suction head according to claim 1, wherein the microplate-mount comprises a gasket.

3. The suction head according to claim 1, wherein an inner surface of the collection container is sloped and wherein the suction vent is placed at a bottom of this slope within the collection container.

4. The suction head according to claim 1, wherein the suction vent comprises a check valve to prevent liquid from leaking out of the suction head in a closed position of the check valve.

5. The suction head according to claim 4, wherein the check valve opens, when a push force from outside of the suction head is applied to a spring loaded body inside of the check valve.

6. (canceled)

7. The suction head according to claim 1, wherein a maximum height of the suction head is less than 30% of its maximum width.

8. A filtration system, comprising the suction head according to claim 1 and a vacuum unit that is connectable to the suction vent of the suction head, where the vacuum unit comprises a vacuum connection that is connectable to a vacuum source.

9. The filtration system according to claim 8, the vacuum unit comprising a vacuum valve that has an open configuration and a closed configuration, where the open configuration opens the connection to the suction head and the closed configuration closes the connection.

10. The filtration system according to claim 8, wherein the suction head is movable independently of the vacuum unit within a predetermined range and where the predetermined range includes at least one contact position for the suction head in which the filtration system has a configuration such that the vacuum unit is connected to the suction head.

11. The filtration system according to claim 10, the vacuum unit comprising a connector unit and, while the suction head is placed in a contact position with the vacuum unit, the connector unit has a connected configuration in which the connector unit is connected to the suction vent of the suction head and an unconnected configuration wherein the connector unit is not connected to the suction head, and where the connector unit is switchable from the connected configuration to the unconnected configuration and vice versa.

12. The filtration system according to claim 11, wherein the connector unit is switched from the unconnected configuration to the connected configuration and vice versa by being moved towards the suction head or away from the suction head.

13. A dispensing and filtration system, comprising the filtration system according to claim 8 and a dispensing unit for an automatic dispensing of liquid into a microplate, comprising a movable carrier for microplates, where the suction head is installed on the carrier.

14. The dispensing and filtration system according to claim 13, comprising a control unit configured to control the automatic dispensing of liquid into the microplate, the movement of the carrier and the opening and closing of the vacuum valve.

15. The dispensing and filtration system according to claim 14, wherein the control unit is further configured to control the switching between the connected configuration and the unconnected configuration of the connector unit.

16. A method for the automatic injection of liquid into a microplate and filtration of liquid out of the microplate comprising the steps of
providing a dispensing unit with a movable carrier;
providing a suction head, the suction head comprising,
a collection container,
a microplate-mount to lock the microplate into position and to seal a connection between the suction head and the microplate where the microplate-mount has an opening towards the collection container, and
a suction vent at the collection container,
providing a filter equipped microplate;
mounting the filter equipped microplate onto the suction head, creating a contiguous cavity between the microplate and the collection container;
installing the suction head onto the movable carrier of the dispensing unit;
injecting a liquid into a number of wells in the microplate using the dispensing unit;
applying a negative pressure at the suction vent of the suction head to filter the liquid out of the microplate into the collection container.

17. The method according to claim 16, comprising the further steps of
moving the movable carrier with the suction head from a dispensing position to a contact position with a vacuum unit;
switching a connector unit of the vacuum unit from an unconnected configuration to a connected configuration; and
after filtering the liquid out of the microplate, switching the connector unit from the connected configuration to the unconnected configuration.

18. The suction head according to claim 2, wherein the gasket is a polytetrafluoroethylene (PTFE) gasket.
